(19) United States
(12) Patent Application Publication
(10) Pub. No.: US 2007/0250467 A1
(43) Pub. Date: Oct. 25, 2007

(54) Systems and methods for targeted content delivery

(75) Inventors: Peter Mesnik, Needham, MA (US); Jeffrey Mesnik, Needham, MA (US); David Fish, Manchester By the Sea, MA (US)

Correspondence Address: FISH & NEAVE IP GROUP;ROPES & GRAY LLP, ONE INTERNATIONAL PLACE, BOSTON, MA, 02110-2624, US

(73) Assignee: iMakeNews, Inc., Waltham, MA (US)

(21) Appl. No.: 11/409,928

(22) Filed: Apr. 24, 2006

(51) Int. Cl. G06F 17/30

(52) U.S. Cl. 707/1

(57) ABSTRACT

The invention, in various embodiments, provides systems and methods directed to tiered delivery of content to viewers. At each tier of the delivery process, content providers and/or authors may modify and/or customize a portion of the content based, at least in part, on tags associated with the content and user profiles of the viewers. In particular, the invention includes a method for providing content over a network from a provider to a plurality of user groups, including a first user group and a second user group, comprising managing and publishing the content, from the provider, being provided to the first user group, receiving and managing, by at least one member of the first user group, the published content, identifying, by at least one member of the first user group, a second user group for receiving the content, the second user group being different from the first user group; accessing, by at least one member of the second user group, the content; and tagging, by at least one of the provider and one member of the first user group, one or more portions of the content with one or more tags, each tag being associated with at least one portion of the content.

### BACKGROUND

Organizations frequently use mechanisms such as electronic mail or website publications to deliver content to its members. However, these mechanisms do not typically provide functionality to deliver the content in a targeted and personalized manner. As a result, either publishers must use large amounts of overhead to manually generate personalized publications for the various members of the organization, or the members are burdened with searching through content that is not relevant to their interests or needs.

Additionally, traditional content delivery mechanisms do not operate in accordance with the tiered organization of users that are inherent to many organizations. For example, employees in a company or members of a supply chain often have the need to send content in accordance with a natural hierarchy of the users.

Thus, there is a need to enable personalized delivery of content over a communication network including a tiered organization of users. It is desirable that the personalized delivery be automated. It is also desirable that the delivery process be suited to a tiered organization or association of content distributors and viewers in the network. Finally, the delivery process should be flexible to allow compatibility with a wide variety of content access methods, including, for example, content syndication mechanisms such as Really Simple Syndication (RSS) feeds and podcasts.

### SUMMARY

The invention, in various embodiments, addresses deficiencies in the prior art by providing targeted and customizable content delivery among a plurality of users, such as content distributors/authors and viewers, related to each other by a tiered organization or association. In certain embodiments, the users include a content provider that manages and/or publishes content, a first user group associated with the provider whose members receive and optionally modify the content managed and/or published by the associated provider, and second user groups associated with respective members of the first user group that access the content. A content provider may include an original equipment manufacturer (OEM). The first user group may include value-added resellers (VARs) associated with the OEM. The second user groups may include customers associated with respective VARs.

For example, an automobile manufacturer may author a press release regarding a new sales promotion. The manufacturer, as the content provider, may then distribute the release to one or more local or regional automobile dealerships. Each dealership, acting as a VAR, may then modify a portion of the release to include dealership-specific information. Then, the dealership may publish the press release via a web page, newspaper, mailing, electronic mailing, podcast, multi-media messaging (MMS), and/or some like distribution mechanism. Consumers may then access the press release via, for example, web browser access to the web page or electronic mail access from an electronic mail application.

In one aspect, the delivered content is personalized and targeted to specific users and/or user groups. In one feature, this is realized, in part, by the OEM and VARs tagging portions of the content while preparing to send the content to end-customers. One or more tags may be associated with the portions of the content. For example, certain tags may relate to subject matter categorizations of the content portions, preferred formatting of the content portions, and/or access information specifying which users in the network have privileges to modify the content portions.

In another feature, the personalized and targeted content delivery is realized, in part, by maintaining user profiles for respective users, such as VARs and/or end-customers. The user profiles may include personal information indicating types of content that are relevant to respective users. In another feature, OEMs choose content to send to VARs by comparing content tags and user profiles of the VARs to find content that may be of relevance to each of the VARs 12. Similarly, VARs send personalized and targeted content to end-users.

In one configuration, the systems and methods provide software modules which enable a fully automated flow of personalized content from sources of content, such as content libraries, user inputted content, and/or third party providers, through the tiered organization of users based on comparisons of content tags and user profiles.

The systems and methods may allow the content to be provided and accessed in a wide variety of forms. In one feature, the content is accessed through content syndication mechanisms such as RSS feeds and/or podcasts.

The systems and methods optionally allow for detecting, aggregating, and analyzing statistics associated with content access. For example, the systems and methods may allow for detecting information including one or more of metadata tags associated with the content, which content each user is viewing, how long each user is viewing the content, how many times a particular link included in the content is clicked, and how many unique users click on a particular link included in the content. These statistics can be monitored, analyzed, displayed, and/or used to modify future content deliveries by the OEM and/or VARs.

In another aspect, the methods include providing content over a network from a provider to a plurality of user groups, including a first user group and a second user group, comprising managing, at the provider, the content and publishing the content to the first user group, receiving and managing, by at least one member of the first user group, the published content, identifying, by at least one member of the first user group, a second user group for receiving the content, the second user group being different from the first user group, accessing, by at least one member of the second user group, the content, and tagging, by at least one of the provider and one member of the first user group, one or more portions of the content with one or more tags, each tag being associated with at least one portion of the content.

In one feature, providing content may include at least one of providing content directed from the provider to the first user group, providing content directed from the provider to the second user group, and providing content directed from the first user group to the second user group.

In another feature, the content may include at least one of text content, image content, video content, and audio content. Accessing the content may include accessing an email including the content. For example, accessing the content may include accessing an email having a link to a website associated with the content, and/or accessing printable documents. In certain configurations, accessing the content includes at least one of accessing a copy of the content, and in others, accessing the content includes accessing a reference associated with an existing copy of the content.

In one feature, accessing the content may include using a content syndication mechanism. Using a content syndication mechanism may include accessing an RSS feed. Accessing an RSS feed may include providing an email with a reference associated with the RSS feed. Accessing an RSS feed may include providing a website with a reference associated with the RSS feed. Accessing the content may include providing access to a podcast. The podcast may distribute at least one of audio data and video data. Accessing a podcast may include providing an email with a reference associated with an RSS feed. Accessing a podcast may include accessing a website with a reference associated with an RSS feed. The methods may include syndicating at least one of audio and video. In one feature, the methods include accessing, by at least one of a member of the first user group and a member of the second user group, a newsletter including the content. For example, the methods may include receiving the content in a newsletter at the first user group.

In one configuration, the methods may include publishing content to websites for a plurality of members of the second user group, wherein each respective website is published for a respective member of the second user group. In another configuration, the methods may include publishing content to websites for a plurality of members of the first user group, wherein each respective website is published for a respective member of the first user group.

In one feature, managing content includes at least one of adding content, deleting content, choosing content, formatting content, forwarding content, modifying content, tagging content, and approving content for delivery. In another feature, choosing content includes choosing content from a database of content maintained by the provider. A third-party content provider may supply the content. In a further feature, the provider is provided with content management tools. Additionally, or alternatively, receiving and modifying the content may include the first user group using content management tools.

In one configuration, tagging a content portion is based at least in part on one of a subject matter categorization of the content portion, a source of the content portion, a title of the content portion, and a media type associated with the content portion. The methods may include tagging a portion of the content with a plurality of hierarchically related tags representing categories of the content. The tags may include information related to a preferred formatting of the content. The tagging may include categorizing the content as one of content provided by the provider that cannot be deleted by members of the first user group, content provided by the provider that can optionally be deleted by members of the first user group, content offered by the provider that may be included by members of the first user group, content created by a third-party provider, and content created by members of the first user group.

In another feature, the methods may include maintaining user profiles for members of the second user group, wherein managing the content includes comparing the tags of the content portions and the user profiles of the members of the second user group. The methods may include choosing, by at least one of the provider and a member of the first user group, content targeted to members of the second user group based on a comparison of the tags associated with the content and the respective user profiles of the members of the second user group. The methods may include maintaining user profiles for members of the first user group, wherein the provider chooses content directed to members of the first user group based on a comparison of the user profiles and the tags associated with the content portions.

In one feature, the methods may include detecting information about the content that at least one of a member of the first user group and a member of the second user group is viewing, and at least one of the provider and a member of the first user group analyzing the detected information. Detecting information may include one or more of identifying metadata tags associated with the content, identifying which content each user is viewing, identifying how long each user is viewing the content, identifying how many times a particular link included in the content is clicked, and identifying how many unique users click on a particular link included in the content. Identifying metadata tags may include identifying one or more of a media type of the content, a source of the content, a title of the content, and a media type of a file associated with the content.

In one configuration, the methods include providing a graphical interface for graphically displaying metrics associated with the detected information. The methods may include allowing the provider to manage content in part by rating the content for subsequent delivery based on the analysis of the detected information. The methods may include the provider maintaining a library of content and the provider modifying the library of content based on the analysis of the detected information. The provider may further manage the content by choosing content directed to members of the first user group based on an analysis of the detected information. Detecting information about the content that members of the second user group are viewing may include detecting information specific to individual ones of the members of the second user group, and personalized content may be delivered to each of the members of the second user group based on the detected information specific to that member.

In another configuration, the methods include providing the first user group with means to organize the members of the second user group into subscriber groups, and providing the first user group with means to choose a different set of content to be delivered to respective subscriber groups. The first user group may organize members of the second user group into subscriber groups based on related user profiles for the members of the second user group.

In a further configuration, the methods include providing the provider with means to organize at least one of the members of the first user group and the members of the second user group into subscriber groups, and providing the provider with means to choose a different set of content to be delivered to respective subscriber groups. The provider may organize the members of the first user group and the members of the second user group based on related user profiles for the members of the first user group and second user group.

In one feature, the methods include providing a plurality of content portions over the network, assigning tags to the portions of the content based on respective categorizations of the content portions, assigning a user profile to the members of the user groups based on at least one of input from the respective users and information associated with the respective users, choosing, at a first filter, content to be delivered from the provider to the respective members of the first user group by comparing the tags with the user profiles of the members of the first user group, and modifying, at a second filter, the provided content by comparing the tags with the user profiles of the members of the second user group. Assigning a tag to a portion of the content may include assigning a plurality of tags to the content portion in a hierarchical sequence, each tag in the sequence identifying a narrower categorization of the content portion than the preceding tag in the sequence. Assigning a user profile to a member may include assigning a user tag identifying a category of interest to the member, and matching, by at least one of the first filter and the second filter, the user tag to at least one tag in the hierarchical sequence of tags. In one configuration of this feature, users access the content via a content syndication mechanism, such as a podcast.

In one aspect, the methods include providing content over a network from a provider to a plurality of user groups, including a first user group and a second user group, comprising managing and publishing the content, from the provider, being provided to the first user group, receiving and managing, by at least one member of the first user group, the published content, identifying, by at least one member of the first user group, a second user group for receiving the content, the second user group being different from the first user group, accessing, by at least one member of the second user group, the content, and analyzing, by at least one of the provider and the first user group, the detected information.

### BRIEF DESCRIPTION OF THE DRAWINGS

These and other features and advantages of the invention will be more fully understood by the following illustrative description with reference to the appended drawings, in which like elements are labeled with like reference designations and which may not be to scale.

FIG. 1 shows a block diagram of a hierarchical organization of users according to an illustrative embodiment of the invention.

FIG. 2 shows a block diagram of a software platform provided to a top tier content provider according to an illustrative embodiment of the invention.

FIG. 3 shows the logical elements of an exemplary user profile for a value-added reseller according to an illustrative embodiment of the invention.

FIG. 4 shows the logical elements of a tagged content portion.

FIG. 5 shows the logical operation of a tag/profile filter according to an illustrative embodiment of the invention.

FIG. 6 shows a block diagram of a software platform similar to the platform of FIG. 2, but provided to an intermediate tier content provider.

FIG. 7 shows a flow diagram of an exemplary content delivery method from an OEM to end-customers via VARs according to an illustrative embodiment of the invention.

FIG. 8 shows a block diagram of a computer system connected to a network according to an illustrative embodiment of the invention.

FIG. 9 shows a diagram of a newsletter according to an illustrative embodiment of the invention.

### DESCRIPTION

The invention, in various embodiments, provides systems and methods directed to tiered delivery of content to viewers. At each tier of the delivery process, content providers and/or authors may modify and/or customize the content based, at least in part, on tags associated with the content and user profiles of the viewers. Content may include information in the form of, for example, text, graphics, pictures, audio, video, and like perceptive forms. The content may include information for the purpose of informing, advertising, or otherwise communicating.

In certain embodiments, the tiered organization is related to a supply chain, wherein a top tier includes original producers of a good or service, intermediate tiers include users that may modify the good or service, and a bottom tier that includes consumers of the good or service. The systems and methods described herein allow for various members in the supply chain to deliver targeted and personalized content to the other members within the tiered framework of the supply chain. The content may include information related to the good or service, such as news information and advertisements. The content can be delivered via email, website publication, podcasts or RSS feeds. In certain embodiments, the content is delivered in the form of an electronic newsletter. These examples are not intended to be limiting, and a more detailed discussion relating to types of content and formats for providing content is set out below. This description is not intended to be limiting, and other applications involving a tiered organization of users, such as employees in a company, are well suited for the systems and methods described herein.

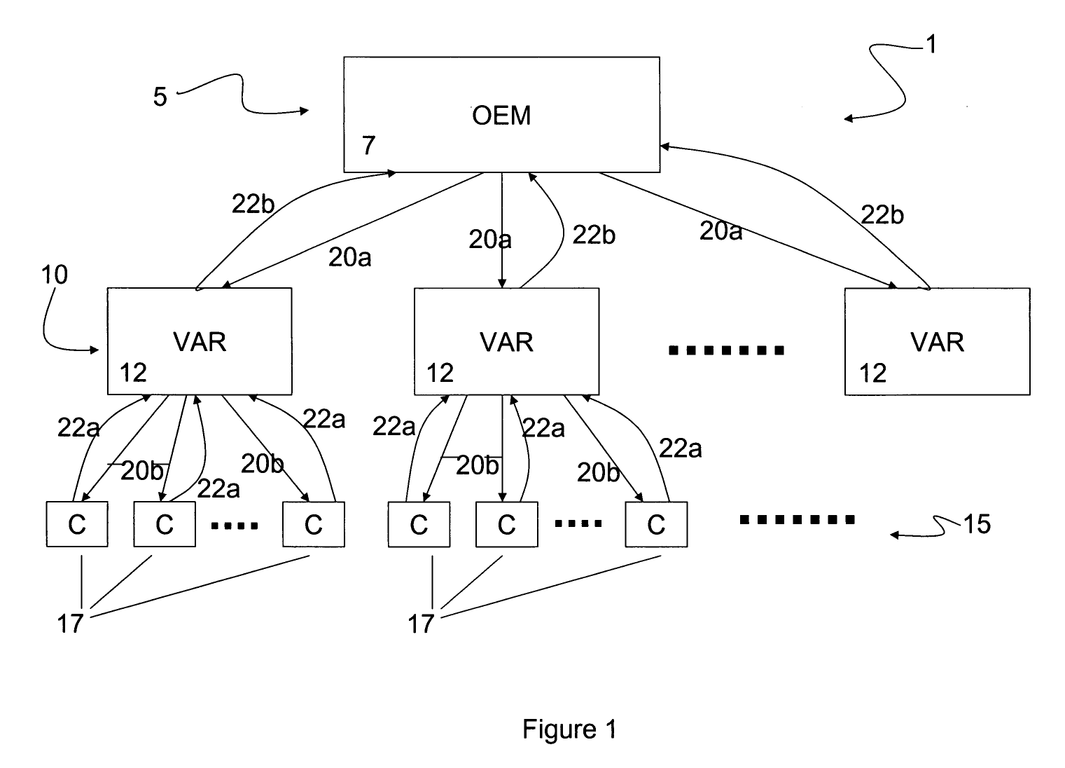

FIG. 1 shows a block diagram of a hierarchical organization of users according to an illustrative embodiment of the invention. In this embodiment, there are three tiers: a top tier 5 that includes a content provider 7, e.g., an Original Equipment Manufacturer (OEM) 7; an intermediate tier 10 includes a first user group, e.g., a plurality of value-added resellers (VARs) 12; and a bottom tier 15 includes a second user group, e.g., a plurality of end-customers 17. As illustrated, groups of end-customers 17 are associated with respective VARs 12. Also, there may be additional OEMs 7 with associated VARs 12 not depicted in FIG. 1. In one illustrative embodiment, the OEM 7 is a national or international automobile manufacturer, the VARs 12 are regional or local automobile dealerships, and the end-customers 17 are automobile buyers. Other embodiments may include more than three tiers.

The flow of content through network 1 is illustrated by arrows 20a-b. Generally, the content is initially provided by the OEM 7. As illustrated by arrows 20a, the OEM 7 publishes and/or delivers the content to the VARs 12. The content may include content directed to the VARs 12, and/or content directed to the end-customers 17 but to be sent via VARs 12. For example, the OEM 7 may be an automobile manufacturer, the VARs 12 may be local automobile dealerships, and the OEM 7 may publish content to the VARs 12 including automobile brochures directed to the automobile customers 17 and informative technical articles on the automobiles directed to the VARs 12. The VARs 12 optionally add, remove, or otherwise modify the content. For example, the VARs 12 may remove the informative technical articles on the automobiles, and modify the automobile brochures in order to customize the brochures for their respective end-customers 17. Then, as illustrated by arrows 20b, the VARs 12 provide content to the end-customers 17. Continuing with the example, the VARs 12 may provide the customized brochures to the end-customers 17 via email in an electronic newsletter, may print the customized brochures for mailing, or may use like distribution methods. Other examples of content include advertisements, videos, and articles. These examples are not intended to be limiting, and other types of content will be discussed below.

The flow of content illustrated in FIG. 1 may be subscription-based. In these embodiments, the OEM 7 sends content to only those VARs 12 that have subscribed to OEM 7, and similarly the VARs 12 only send content to those end-customers 17 that have subscribed to VAR 12. The VARs 12 and the end-customers 17 can unsubscribe to prevent future deliveries of content.

The OEM 7 and/or the VARs 12 may detect information such as statistics 22a-b regarding the content-access behavior of the end-customers 17 and/or the VARs 12. The statistics generally relate to viewing patterns of the end-customers 17 and the VARs 12 including, for example, the number of times various content portions are accessed by viewers and types of content accessed by viewers. The statistics can be used by the VARs 12 to gain information regarding content accessed by the end-customers 17 and these statistics are used for a wide variety of purposes, including to gain a better understanding of customer interests and behaviors to improve business practices and/or to provide greater personalization in future deliveries of electronic newsletters 203. Similarly, the OEM 7 can gain information regarding content accessed by the VARs 12 and/or end-customers 17 for similar purposes.

Continuing with the illustrative example discussed above, in which the OEM 7 is an automobile manufacturer, the VARs 12 are local automobile dealerships, and the end-customers 17 are individual automobile customers, the statistics illustrated by arrows 22b may include analytic information associated with end-customer 17 preferences. For example, by tagging content portions in the electronic newsletter with respective automobile types associated with the content portions (i.e., SUV, sedan, sports car), each VAR 12 can identify, based on a detection of which content portions are being accessed most frequently by its end-customers 17, which automobile type is of most interest to the end-customers 17. As will be discussed below, the VARs 12 may alter subsequent content deliveries in view of the statistics 22b in order to make the subsequent deliveries more relevant to the end-customers 17. Similarly, the OEM 7 can identify, based on a detection of which content portions are being accessed more frequently by a VAR 12 and/or which content portions are being accessed more frequently by the end-customers 17 of the VAR 12, types of content that are of high relevance to the VARs 12.

The VARs 12 collect statistics related to content-access habits of end-customers 17 as indicated by arrow 22a. Similarly, the OEM 7 collects statistics related to content-access habits of VARs 12 as indicated by arrow 22b. In addition, or in the alternative, statistics related to end-customer 17 content-access habits are accessed by the OEM 7, and it is to be understood that arrow 22b may include these statistics. The statistics may be accessed from VARs 12, as depicted, from end-customers 17, or from a third party site not depicted. The above example are not intended to be limiting, and the statistics 22a-b as well as the implementation of content tags are discussed in more detail below.

In certain embodiments, the targeted content delivery discussed herein from the OEM 7 to respective VARs 12 and from the respective VARs 12 to respective end-customers 17 is automated. The tools modules included in software platforms which enable the flow of content, and which will be discussed below, function independently and automatically with little or no additional interaction or intervention. In particular, subsequent to the OEM 7 sending content to the VARs 12, the flow of content 20b and, optionally, the flow of statistics information 22a-b illustrated in FIG. 1 occurs automatically. The flow of content 22a from OEM7 to VARs 12 can itself be automated by programming software platforms and computers, discussed below, to automatically deliver content at programmed times. In one such automated embodiment, the content is provided through content syndication mechanisms such as RSS feeds and/or podcasts.

Generally, the systems and methods are realized by software platforms provided to top tier 5 and/or intermediate tier 10 users. The software platforms include a variety of tools and modules, and the functionalities of these tools and modules will now be discussed in more detail. The software platforms may be applications codified in programming languages based on C, C++, C#, COBOL, BASIC, Java®, assembly language, and like computer program languages and may be compatible with platforms such as Windows, Linux, UNIX, or other operating systems. The platforms may also use scripting languages such as Active Server Pages (ASP), ColdFusion, JavaScript, or .Net.

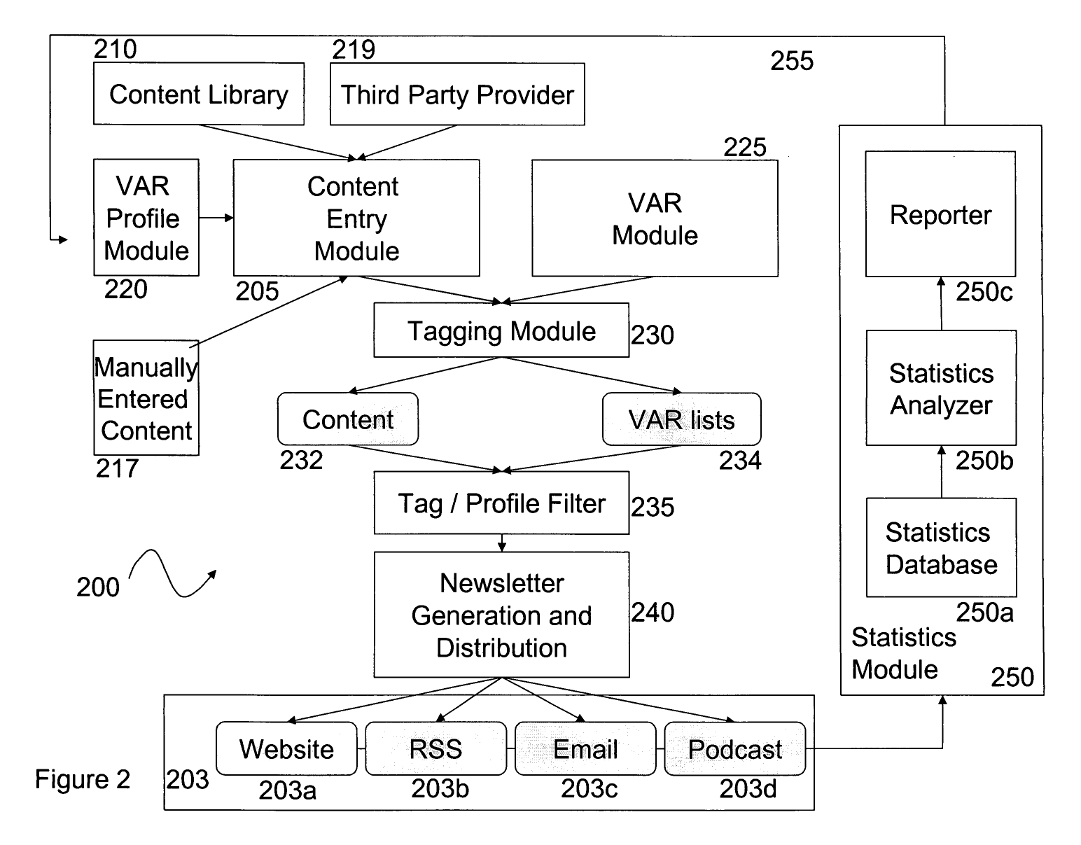

FIG. 2 shows a block diagram of a software platform provided to the OEM 7 according to an illustrative embodiment of the invention. Generally, the tools and modules of the software platforms 200 allow the OEM 7 to manage and deliver targeted and customizable content directed to other VARs 12 and end-customers 17 in network 1. In this illustrative embodiment, the content is delivered in the form of an electronic newsletter 203. As mentioned above, this content may include content intended for VARs 12, and/or content intended for end-customers 17 and sent via respective VARs 12. As used herein, managing content generally refers to adding content, deleting content, choosing content, formatting content, forwarding content, and/or approving content for delivery.

In certain embodiments, the software platform 200 is installed and operated locally at the site of the OEM 7. In these embodiments, the OEM 7 itself may operate or maintain the software platform 200, or a third party may operate or maintain the software platform 200 as a service to the OEM 7. Alternatively, the software platform 200 may be maintained at a third party (not shown). Again, in these embodiments, the OEM 7 itself may operate or maintain the software platform 200 by remotely accessing the software platform 200, or a third party may operate or maintain the software platform 200 as a service to the OEM 7.

The depicted software platform 200 includes a content entry module 205 for entering content for inclusion in the electronic newsletter 203, a VAR profile module 220 for maintaining information specific to various VARs 12 in network 1, a VAR module 225 for grouping and organizing lists of VARs that receive electronic newsletters 3, a tagging module 230 to tag content portions with information specific to the content portions, a tag/profile filter 235 to compare VAR profiles and content tags such that personalized and relevant content is targeted to appropriate VARs 12, a newsletter generation and distribution module 240 for delivering electronic newsletters 203, and a statistics module 250 for collecting, analyzing, and reporting content-access statistics.

We now discuss the content entry module 205, which provides an interface to a user for entering content for inclusion in the electronic newsletter 203. The OEM 7 can include a variety of content in electronic newsletter 203 to serve a variety of purposes. In certain instances, the OEM 7 will include content that the VARs 12 use to facilitate their business practices. For example, the electronic newsletter 203 may include articles and/or advertisements directed to a good or service sold by the VAR 12. In other embodiments, the OEM 7 includes files having printable documents, such as pamphlets or brochures, for the VARs 12 to print and make use of. The electronic newsletter 203 may include content portions that include at least one of textual content, image content, video content, and audio content. The electronic newsletter 203 may be delivered in a wide variety of formats, such as in the form of one or more websites or electronic mail messages, and this will be discussed in greater detail below.

In certain embodiments, a variety of content is maintained in the content library 210, and content entry module 205 provides an interface to select content from among the content stored in the content library 210 for inclusion in the newsletter 203. For example, the content library may serve as a repository of content that the OEM 7 frequently delivers to the VARs 12 and/or the end-customers 17 for ease of access. In certain embodiments, the content library is a programmable and query-able relational database. Exemplary platforms for implementing the database include Oracle, SQL Server, and DB2.

In certain embodiments, the content entry module 205 provides an interface for parties or individuals affiliated with OEM 7 to manually enter content into software platform 200 for inclusion in the electronic newsletter 203. For example, parties affiliated with OEM 7 may select files locally saved on their respective computers for inclusion in the electronic newsletter 203. The content entry module 205 can convert the files, if necessary, into a usable format for inclusion in electronic newsletter 203. By way of example, a party affiliated with OEM 7 can choose a locally saved document for inclusion in electronic newsletter 203, and content entry module 205 can convert the document to an appropriately codified format, such as HTML files.

The content entry module 205 may include an interface for inclusion of manually entered content 217. By way of example, the content entry module 205 may include a text editor in which an individual or party affiliated with the OEM 7 manually enters textual content for inclusion in the electronic newsletter 203. Other editors, such as HTML editors, may be included and allow for manual inclusion of a variety of media types. The content entry module 205 also allows for inclusion and delivery of content in other formats, such as an Extensible Markup Language (XML) feed. The XML feed can be provided by the OEM 7 or a third party provider 219. Other content formats, including formats that may be based on XML specifications such as RSS feeds, will be discussed in more detail below.

Content entry privileges need not be restricted to the OEM 7. A third party provider 219 may also have access to the content entry module 205. The third party provider 219 may be an advertiser that pays for the right to include advertisements in electronic newsletter 203. The third party provider 219 may manually enter content using the interface provided by the content entry module 205, select content from content library 210, and/or select content from its own content library (not shown).

In addition to providing an interface for content entry, the content entry module 205 may provide for including VAR profile information from the VAR profile module 220. In one embodiment, VAR profiles are used to maintain VAR-specific information about various VARs 12 in network 1 so that content relevant to those VARs 12 can be identified to enable the targeted delivery of personalized content to those VARs 12.

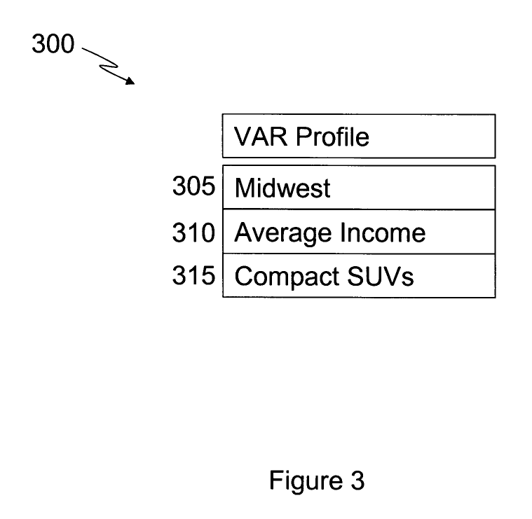

FIG. 3 shows the logical elements of an exemplary user profile for a value-added reseller according to an illustrative embodiment of the invention. In certain embodiments, VAR profile module 220 includes a VAR profile for each of one or more of the VARs 12. Each VAR profile 300 includes VAR-specific information including, for example, demographic information such as geographic location information 305 associated with VAR 12. The VAR profile 300 may include other information such as an average income 310 for the end-customers 17 associated with VAR 12, age distributions, sex distributions, ethnicity distributions, education distributions, as well as other like information. The demographic information, such as information 310, may be related to end-customers 17 associated with the VAR 12, but may also be related to the VAR 12 itself.

In another embodiment, the VAR profile 300 also includes subject matter 315 of interest and/or relevance to the VAR 12. The entries in the VAR profile 300 are used to deliver targeted content from OEM 7 that is of relevance to VAR 12 and/or its associated end-customers 17.

The information contained in the VAR profile 300 may be provided in several alternative ways. The VARs 12 themselves may provide the information upon, for example, subscription with the OEM 7. The OEM 7 can collect the information itself. Finally, the statistics module 250 can provide information to VAR profile module 220, as will be discussed below.

Returning to FIG. 2, the software platform 200 further includes a VAR module 225. In one embodiment, the VAR module 225 maintains a record of potential recipients of electronic newsletters 203. The VAR module 225 may maintain a record of VARs 12 and other requisite information such as their respective email addresses.

The software platform 200 may also include a tagging module 230. In certain embodiments, the tagging module 230 serves two general purposes: it tags content provided via content entry module 205 with content-specific tags, and it tags VARs 12 identified in VAR module 225 according to VAR profiles from VAR profile module 220.

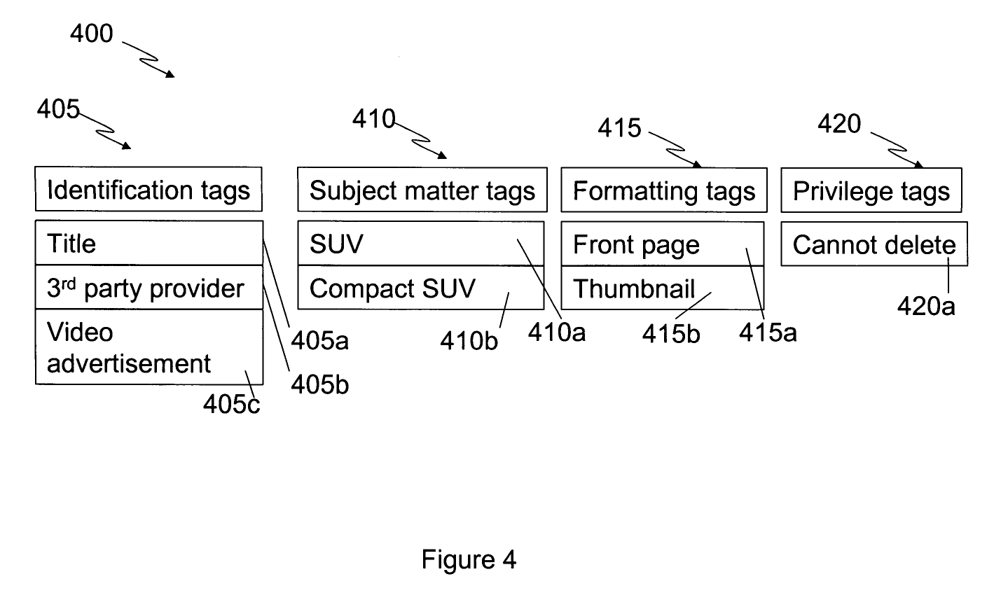

FIG. 4 shows the logical elements of a tagged content portion according to an illustrative embodiment of the invention. In one embodiment, the tagging module 230 tags individual content portions with content-specific tags that may relate to a wide variety of content-specific information. For example, the tags may include identifying information 405 associated with the content portion. This may include a title 405a or other identifier, a source 405b of the content portion 400, and/or a media type 405c of the content portion.

In another embodiment, the tags identify subject matter categorizations 410 of the content portion, and these content-specific tags may include hierarchical categorizations of content portions. By way of example, the subject matter tags 410 may include a high level subject matter tag 410a, and one or more lower level tags 410b that more specifically refine the categorization provided by the high level subject matter tag 410a.

Content portions may be provided with formatting tags 415. The formatting tags 415 may specify information regarding a preferred and/or required manner in which the content portion 400 shall be presented in electronic newsletter 203. For example, formatting tags 415 may include location tags 415a indicating a location on the electronic newsletter 203 in which the content portion 400 (or a reference to the content portion) will be displayed. Formatting tags 415 may also include presentation tags 415b indicating how the content portion (or the reference to the content portion) will be displayed.

Content portions may be provided with privilege tags 420. In one embodiment, privilege tags 420 indicate which parties have rights to modify and/or remove the content portion 400. In the logical depiction of FIG. 4, a tag 420a indicates that the video advertisement 400 cannot be deleted. However, other privilege tags 420 indicate that the content portion 400 can be optionally deleted by VARs 12, or must be deleted by VARs 12 after the content portion 400 has been accessed by VARs 12 and before the VARs 12 forward the electronic newsletter 203 on to end-customers 17. The software platform 200 can be codified with program logic to interpret and enforce the privilege tags.

In certain embodiments, the tagging is realized by codifying the tags 405, 410, 415, and 420 into software code and/or logic, and associating the code with the content portions as metadata associated with that content portion.

Returning to FIG. 2, tagging module 230 also tags users identified in VAR module 225 with VAR tags that correspond to entries in the VAR profiles from VAR profile module 220. For example, the tagging module 230 can tag a VAR 12 with a geographic tag corresponding to the geographic categorization 305, a subject matter tag corresponding to the subject matter categorization 315, and/or a demographic tag 310 corresponding to the demographic categorization 310. As will be discussed below, the tag/profile filter 235 coordinates distribution of content based on a comparison of content tags and the VAR tags provided to VARs 12 by the tagging module 230.

In one optional feature, the tagging module 230 organizes mailing lists 234 of VARs 12 based, at least in part, on respective VAR profiles of the VARs 12 from VAR profile module 220. In one embodiment, the tagging module 230 organizes VARs 12 into mailing lists based on subject-matter interests of the VARs 12. Other mailing lists may be organized based on other user-specific information, such as demographic information and/or geographic information of VARs 12. As illustrated with respect to FIG. 3, a VAR profile of a VAR 12 may include several fields, and thus each VAR 12 can be included in several mailing lists. By way of example, a VAR 12 with VAR profile 300 will be included in a mailing list directed to a low-level subject matter categorization 315, a higher-level categorization such as “SUV” which may not be included in the VAR profile 300, and a geographic categorization 305. In certain embodiments, each mailing list is associated with more than one categorization.

Personalized content delivery is achieved, in part, by a comparison of tagged content 232 and VAR profiles. This functionality is provided by the tag/profile filter 235, which can coordinate the distribution of the tagged content 232 to appropriate users. The tag/profile filter 235 can associate content portions to individual VARs 12 based on comparisons of the tagged content 232 with VAR tags that, as mentioned above, are based on the VAR profile entries, such as entries 305, 310, and 315 in FIG. 3. For each portion of tagged content, the filter 235 associates the content portion to one or more VARs 12. This is achieved, for example, by direct matching of a content tag with VAR tags. For example, a content portion having a subject matter categorization 410b (FIG. 4) may be associated with a user having a VAR tag based on VAR profile entry 315 (FIG. 3). Additionally, a content portion with categorization 410a (FIG. 4) may be associated with mailing a user having related but not identical VAR tag based on VAR profile entry 315.

Furthermore, the tag/profile filter 235 is, in certain embodiments, programmed to generate other associations between content tags and VAR tags. For example, the tag/profile filter 235 may be programmed to associate content having subject-matter categorization 410a with users identified based on certain geographic information.

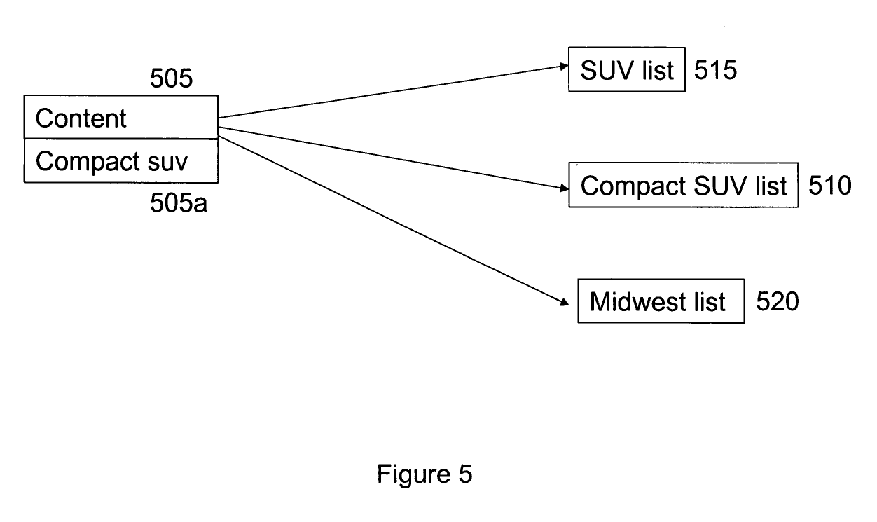

FIG. 5 shows another logical operation of a tag/profile filter 235 according to an illustrative embodiment of the invention. In certain embodiments, the tag/profile filter 235 coordinates distribution based on a comparison of content tags and mailing list identifications. For each portion of tagged content, the filter 235 associates the content portion to one or more mailing lists. This is achieved, for example, by direct matching of a content tag with a mailing list identification. For example, a content portion 505 having a subject matter categorization 505a may be associated with mailing list 510, identified based on the same subject matter categorization. Additionally, the content portion 505 may be associated with mailing list 515, identified based on subject matter categorizations related to the subject matter categorization 505a. In this example, mailing list 515 is identified based on a higher level categorization of the subject matter categorization 505a.

Furthermore, the tag/profile filter 235 is, in certain embodiments, programmed to generate other associations between content tags and mailing lists. For example, the tag/profile filter 235 may be programmed to associate content having subject-matter categorization 505a with mailing lists 520 identified based on certain geographic information.

In this example, the content portion 505 is associated with the mailing lists 510, 515, and 520 generated by the tagging module 230 based on VAR profiles from VAR profile module 220. Returning to FIG. 2, newsletter generation and distribution module 240 aggregates the results of the tag/profile filter 235 to generate, publish, and distribute one or more electronic newsletters 203. The newsletter generation and distribution module 240 can produce a targeted electronic newsletter 203 for each one of the VAR lists 234 and/or individual VARs 12. The electronic newsletter 203 may be generated in accordance with the content tags, such as the formatting tags 415 and the privilege tags 420 in FIG. 4.

The content may be aggregated and published in a wide variety of formats. In certain embodiments, the electronic newsletter 203 is presented within the body of the electronic mail message 203c. In this case, the OEM 7 is directly generating and sending the content to the VARs 12. Alternatively, the electronic mail message 203c can include a reference, such as a hyperlink, to a website 203a. In this case, the OEM 7 is providing a reference associated with existing and published content.

In one embodiment, various levels of personalization are realized. In the instance where the tag/profile filter 235 has associated content portions 505 with mailing lists 234, one or more websites 203a can be published specifically for each of the mailing lists 234. In the instance where the tag/profile filter 235 has associated content portions 505 with individual ones of the VARs 12 that are identified in the subscriber module 225, single websites 203a can be published specifically for respective ones of the individual VARs 12. Access to the website 203a may be provided by a reference in an electronic mail message 203c. Alternatively, VARs 12 may be informed of an address for their respective websites 203a using other standard methods. In another alternative, a single website is published that dynamically modifies its content and/or presentation based on the VAR 12 that accesses the website. For example, the website can dynamically modify its content and/or presentation based on VAR profile entries such as those depicted in FIG. 3. This can be realized by using, for example, one of the scripting languages listed herein.

Content may also be delivered using content syndication mechanisms. In certain embodiments, the OEM 7 provides access to really simply syndication (RSS) feeds 203b by including references to the RSS feeds in, for example, an email 203c or a website 203a. The OEM 7 can similarly provides access to podcasts 203d. In certain embodiments, access to podcasts is provided by including references to RSS feeds in an email 203c or a website 203a. In another alternative, RSS feeds themselves comprise the content. More particularly, RSS feeds can deliver the newsletter 203 to the VARs 12.

As mentioned above, the OEM 7 accesses statistics information 22b. The statistics module 250 includes a statistics database 250a for storing statistics, a statistics analyzer 250b for aggregating and otherwise analyzing statistics, and a reporter 250c for displaying statistics. The statistics include a wide variety of information related to content access behavior of the VARs 12. Exemplary statistics include information identifying which content portions the VARs 12 are viewing, lengths of time that content portions are viewed, numbers of unique clicks of links included in the content, and/or numbers of unique users accessing particular content portions. The statistics are related to individual ones of the VARs 12. However, in other embodiments, in order to protect the privacy of the VARs 12, only aggregate statistics directed to overall usage patterns of a plurality of the VARs 12 are collected.

The statistics information is stored in the statistics database 250a. The statistics analyzer 250b aggregates and analyzes the statistics information. The analysis includes identifying frequently accessed content portions 505, infrequently accessed content portions 505, and/or trends directed to the content portions 505. The trends can include temporal trends, e.g., identifying how content access for particular content portions 505 vary over a period of time. The trends may include geographic trends, e.g., trends indicating how content access for particular content portions vary over geographic locations. In certain embodiments, the statistics are directed to content tags provided by the tagging module 230, enabling the statistics analyzer 250b to generate higher level analytics directed to, for example, subject matter categorizations, genre categorizations, and/or media type categorizations.

The statistics analysis generated by the statistics analyzer 250b may be reported by the reporter 250c. Reporter 250c can provide a graphical interface by which OEM 7 views charts and graphs depicting the trends and other analytics aggregated by statistics analyzer 250b. In certain configurations, the reporter 250c automatically provides statistics reports to the OEM 7 based on certain trigger times or trigger events. The reporter 250c may send reports to the OEM 7 automatically according to a fixed schedule of trigger times that can occur once (i.e., 1 hour, 1 day, 3 days, and/or 7 days after the mailing of the newsletter 203) or can be configured to be periodic (i.e., every hour after delivery of the newsletter 203, daily after the mailing of the newsletter 203, every 3 days after mailing the newsletter 203, weekly after mailing the newsletter 203), or any other suitable time period. The reporter 250c may also send the reports based on a trigger event. For example, the reporter 250c may send the report each time a user, or each time a certain number of users, accesses a piece of content. The reports can be provided in a human-readable format, such as via email or a published website. The reports can also be provided in a machine-readable format, such as via an XML data file to be inserted into a customer relationship management (CRM) system of the OEM 7.

In other embodiments, as illustrated by arrow 255, the OEM 7 makes use of the statistics 22b to modify content and/or formatting of future deliveries to the VARs 12. For example, the statistics related to certain VARs 12 provided to statistics module 250 are used to update VAR profiles using VAR profile module 220 to more accurately reflect tastes and interests of those VARs 12. In certain embodiments, the contents of the content library 210 are modified based on the statistics to include content that is of higher relevance to VARs 12.

As mentioned above, in one embodiment, after the OEM 7 delivers the electronic newsletters 203 to the VARs 12, each of the VARs 12 modifies the electronic newsletter 203 and then deliver the electronic newsletter 203 to the end-customers 17.

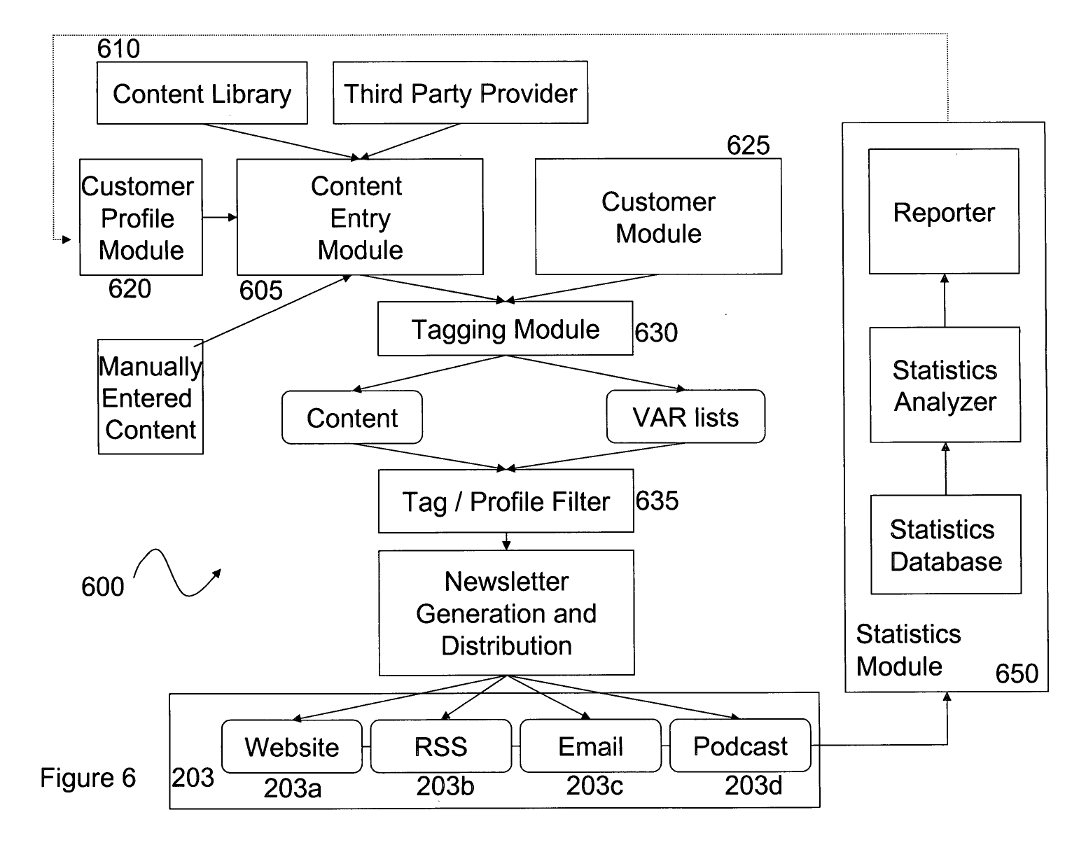

FIG. 6 shows a block diagram of a software platform 600 similar to the platform 200 of FIG. 2, but provided to VARs 12, according to an illustrative embodiment of the invention.

However, there are some notable differences which we now discuss. In particular, software platform 600 maintains end-customer 17 profiles in customer profile module 620, which performs similar functions as VAR profile module 220 in FIG. 2. However, customer profiles are directed to end-customers 17 instead of VARs 12. Customer profiles may include similar fields as VAR profiles as discussed above.

Similarly, the customer module 625, the tagging module 630, and the statistics module 650 are similar to the VAR module 225 and the tagging module 230 of FIG. 2, but function with respect to the end-customers 17 instead of the VARs 12. The content entry/modification module 605 is similar functionally to the content entry module 205 provided to the OEM 7. However, the module 605 may include additional functionality to add, remove, and/or otherwise modify content in the electronic newsletter 203.

The VAR 12 may add content using the content entry/modification module 605 in a similar manner as described with respect to the OEM 7 that adds content using the content entry module 205. In certain embodiments, the content library 610 provided to the VAR 12 is the same as the content library 210 used by the OEM 7. However, in other embodiments, the VAR 12 maintains a separate content library 610.

The content entry/modification module 605 may allow the VAR 12 to remove content portions 505, add new content portions 505, and/or modify existing content portions 505. The VAR 12 can remove content portions 505 included in electronic newsletter 203 by the OEM 7 and directed to VAR 12, but may retain content portions 505 included by OEM 7 and directed to end customers 17. The VAR 12 may decide on removal or modification of content in accordance with the privilege tags 420 discussed above with respect to FIG. 4. As mentioned previously, the content portions 505 that are included by OEM 7 and directed to end customers 17 may include privilege tags 420. These privilege tags 420 may indicate that the content portion 505 cannot be deleted by the VAR 12. The privilege tags 420 may alternatively indicate that the content portion 505 can optionally be deleted by the VAR 12. Other exemplary privilege tags 420 may indicate that the content portion 505 can be deleted, but not modified, or can be modified, but not deleted. The software platform 600 can be codified with program logic to interpret and enforce the privilege tags. For example, in certain embodiments the software platform 600 includes code that identifies a privilege tag indicating that a content portion 505 cannot be deleted by the VAR 12, and displays an error notification when the VAR 12 attempts to delete the content portion 505. The remainder of the modules illustrated in FIG. 6 may function in a manner similar to respective modules in FIG. 2. As with the software platform 200, in certain embodiments, the software platform 600 is installed and operated locally at the site of the VARs 12. In these embodiments, the VARs 12 themselves may operate or maintain the software platform 600, or a third party may operate or maintain the software platform 600 as a service for the VARs 12. Alternatively, the software platform 600 may be maintained at a third party (not shown). Again, in these embodiments, the VARs 12 themselves may operate or maintain the software platform 600 by remotely accessing the software platform 600, or a third party may operate or maintain the software platform 600 as a service to the VARs 12.

The software platforms 200 and 600 may be programmed as a separate applications, as illustrated in FIGS. 2 and 6, but may also be programmed as a common application that operates differently depending on the user (VAR 12 or OEM 7).

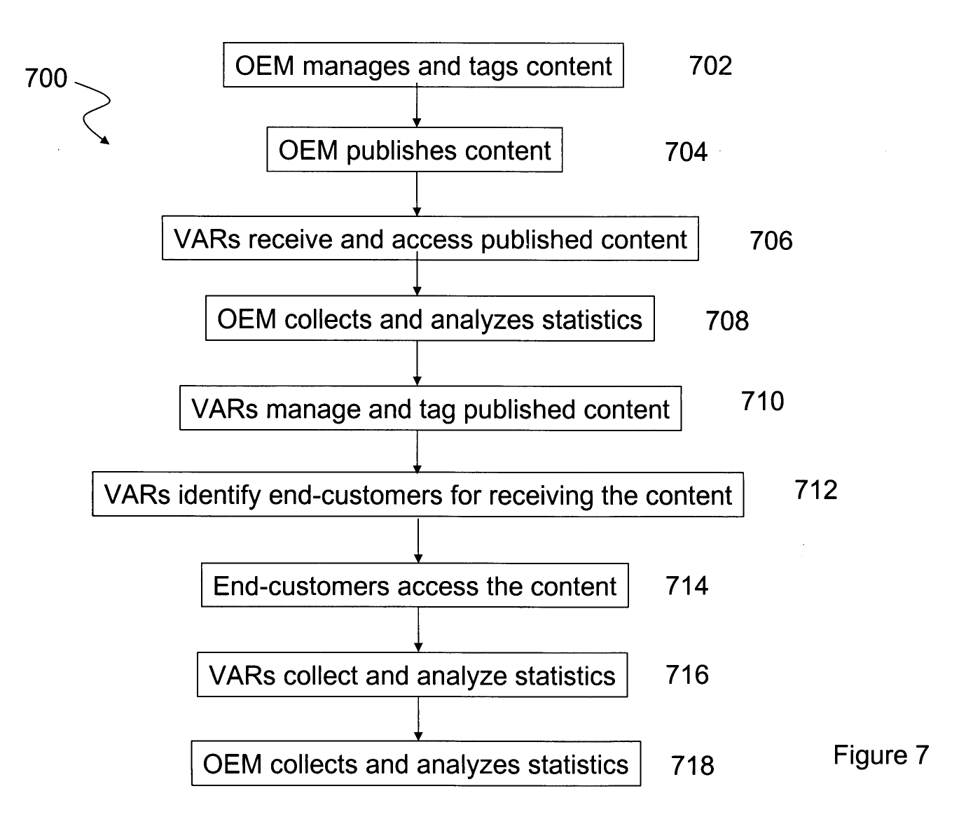

FIG. 7 shows a flow diagram 700 of an exemplary content delivery method from an OEM 7 to end-customers 17 via VARs 12 according to an illustrative embodiment of the invention. The method employs the various tools and modules included in software modules 200 and 600 discussed above. In the exemplary method, an OEM 7 manages and tags content (step 702) using the software platform 200 and, in particular, using tagging module 230. The OEM 7 publishes the content (step 704) in, for example, electronic newsletter 203. VARs 12 receive and optionally access the published content (step 706). The OEM 7 optionally collects statistics (step 708) relating to the content accessed by VARs 12 in step 715 using statistics module 250. The VARs 12 manage and tag the published content (step 710) using software platform 600 and, more particularly, using the tagging module 630. The VARs 12 identify end-customers 17 for receiving the content (step 712) using the customer profile module 620, the customer module 625, and the tag/profile filter 635. The end-customers 17 access the content (step 714). The VARs 12 then, optionally, collect statistics (step 716) relating to the content accessed by the end-customers 17 in step 735 using the statistics module 650. Finally, the OEM 7, optionally, collects and analyzes statistics relating to content accessed by the end customers 17 and/or content accessed by the VARs 12 in step 718.

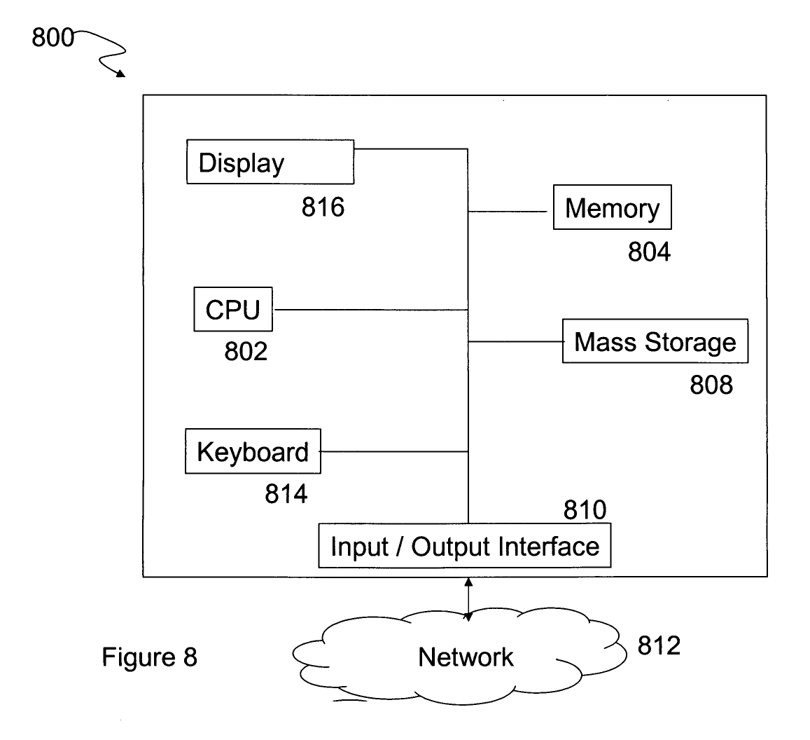

FIG. 8 shows a block diagram of a computer system 800 connected to a network 812 according to an illustrative embodiment of the invention. In one exemplary embodiment, the software platforms 200 and 600, as well as databases such as the content libraries 210 and 610, are implemented on the computer system 800. The OEMs 7, the VARs 12, and the end-customers 17 may be interconnected via network 212. The exemplary computer system 800 includes a central processing unit (CPU) 802, a memory 804, and an interconnect bus 806. The CPU 802 may include a single microprocessor or a plurality of microprocessors for configuring computer system 800 as a multi-processor system. The memory 804 illustratively includes a main memory and a read only memory. The computer 800 also includes the mass storage device 808 having, for example, various disk drives, tape drives, etc. The main memory 804 also includes dynamic random access memory (DRAM) and high-speed cache memory. In operation, the main memory 804 stores at least portions of instructions and data for execution by the CPU 802.

The mass storage 808 may include one or more magnetic disk or tape drives or optical disk drives, for storing data and instructions for use by the CPU 802. At least one component of the mass storage system 808, preferably in the form of a disk drive or tape drive, stores the database used for processing the imaging and targeting of system 100 of the invention. The mass storage system 808 may also include one or more drives for various portable media, such as a floppy disk, a compact disc read only memory (CD-ROM), or an integrated circuit non-volatile memory adapter (i.e. PC-MCIA adapter) to input and output data and code to and from the computer system 800.

The computer system 800 may also include one or more input/output interfaces for communications, shown by way of example, as interface 810 for data communications via the network 812. The data interface 810 may be a modem, an Ethernet card or any other suitable data communications device. The data interface 810 may provide a relatively high-speed link to a network 812, such as an intranet, internet, or the Internet, either directly or through an another external interface (not shown). The communication link to the network 812 may be, for example, optical, wired, or wireless (e.g., via satellite or cellular network). Alternatively, the computer system 800 may include a mainframe or other type of host computer system capable of Web-based communications via the network 812. The data interface 810 allows for delivering content, and accessing/receiving content via network 812.

The computer system 800 also includes suitable input/output ports or use the interconnect bus 806 for interconnection with a local display 816 and keyboard 814 or the like serving as a local user interface for programming and/or data retrieval purposes. Alternatively, server operations personnel may interact with the system 800 for controlling and/or programming the system from remote terminal devices via the network 812.

The computer system 800 may run a variety of application programs and stores associated data in a database of mass storage system 808. By way of example, the mass storage system 808 can store content library 210 or the statistics database 250 for the OEM 7. Alternatively, the mass storage system 808 can store the content library 610 or the statistics database 650 for a VAR 12.

The components contained in the computer system 800 are those typically found in general purpose computer systems used as servers, workstations, personal computers, network terminals, and the like. In fact, these components are intended to represent a broad category of such computer components that are well known in the art. Certain aspects of the invention may relate to the software elements, such as the tools and modules included in software platforms 200 and 600.

In one embodiment, the software platforms 200 and 600 are implemented on computer readable mediums operatively coupled to computer systems, such as system 800. Such a computer readable medium may include the CPU 802, the memory 804, the mass storage 808, and/or other similar mediums external to computer system 800. The computer readable medium may include computer readable program code implementing the software applications 200 and/or 600.

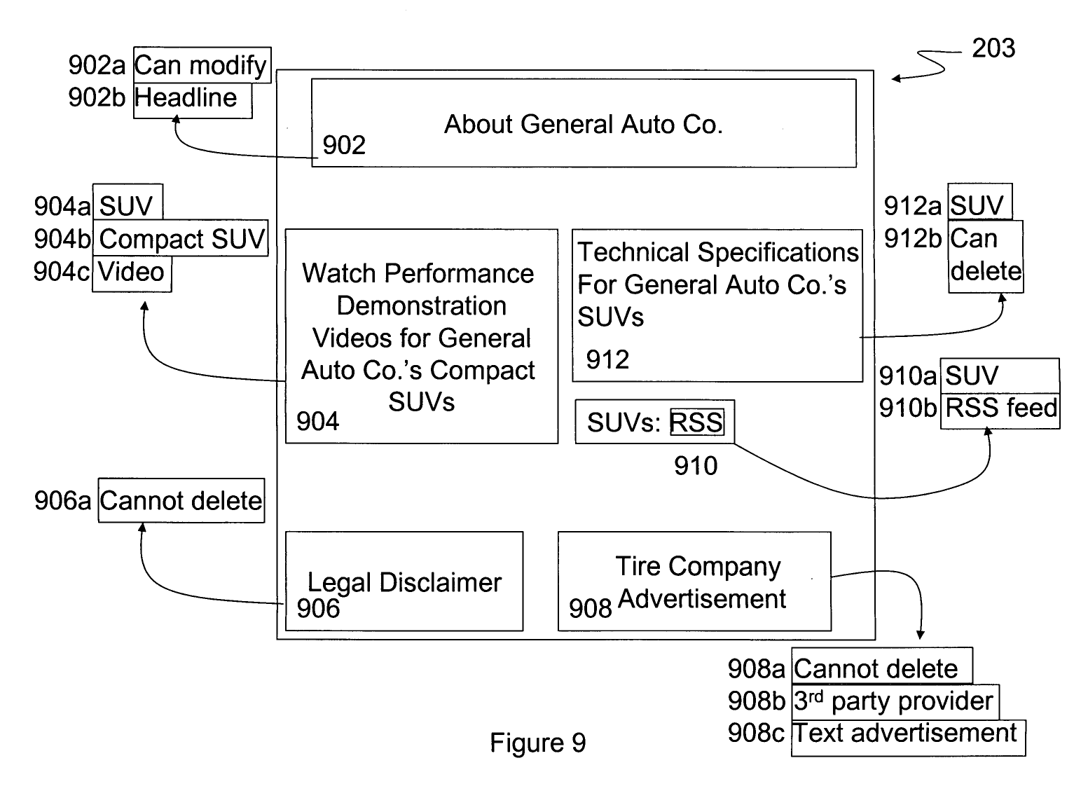

FIG. 9 shows a diagram of a newsletter 203 according to an illustrative embodiment of the invention. This example newsletter is provided by an OEM 7 to a VAR 12 in the body of an email, and continues the example discussed above in which the OEM 7 is an automobile manufacturer, the VAR 12 is a local automobile dealership, and the end-customers 17 are individual automobile customers. The newsletter includes various portions 902, 904, 906, 908, 910, and 912 of content. Also illustrated are certain tags associated with the content portions. The Content portion 902 is a reference (i.e., a link) to general informational article, and includes a privilege tag 902a indicating that the VAR 12 can modify the content portion 902 to, for example, customize it for its end-customers 17. The depicted content portion 902 also includes a formatting tag 902b indicating that the VAR 12 must include the reference to the content portion 902 as the headline of the electronic newsletter 203. The content portion 904 is a reference to demonstration videos, and includes two subject matter tags 904a and 904b indicating that the content portion 904 relates to SUVs and, more particularly, compact SUVs, respectively. Also included is a media type tag 904c, indicating that the content portion 904 of content is video media. The content portion 906 includes a privilege tag 906a indicating that the legal disclaimer cannot be deleted by the VAR 12, and thus must be published to the end-customers 17. The content portion 908 is a third party advertisement. The content portion 908 includes a privilege tag 908a, a tag 908b indicating the source of the portion 908, and a tag 908c indicating the media type of the portion 908. The content portion 910 includes a reference providing access to an RSS feed directed to SUVs, and includes a subject matter tag 910a and a media type tag 910b. The content portion 912 includes SUV technical specifications intended for VARs 12, and thus includes a subject matter tag 912a and a privilege tag 912b indicating that the VAR 12 can delete or suppress the content portion 912 before publishing the newsletter 203 to end-customers 17.

While this invention has been particularly shown and described with references to preferred embodiments thereof, it will be understood by those skilled in the art that various changes in form and details may be made therein without departing from the scope of the invention encompassed by the appended claims.

We claim:

1. A method for providing content over a network from a provider to a plurality of user groups, including a first user group and a second user group, comprising:
managing, at the provider, the content and publishing the content to the first user group,
receiving and managing, by at least one member of the first user group, the published content,
identifying, by at least one member of the first user group, a second user group for receiving the content, the second user group being different from the first user group;
accessing, by at least one member of the second user group, the content; and
tagging, by at least one of the provider and one member of the first user group, one or more portions of the content with one or more tags, each of the one or more tags being associated with at least one portion of the content.

2. The method of claim 1, wherein
providing content includes at least one of providing content directed from the provider to the first user group, providing content directed from the provider to the second user group, and providing content directed from the first user group to the second user group.

3. The method of claim 1, wherein the content includes at least one of text content, image content, video content, and audio content.

4. The method of claim 1, wherein accessing the content includes accessing an email including the content.

5. The method of claim 1, wherein accessing the content includes accessing an email having a link to a website associated with the content.

6. The method of claim 1, further comprising
publishing content to websites for a plurality of members of the second user group, wherein each respective website is published for a respective member of the second user group.

7. The method of claim 1, further comprising
publishing content to websites for a plurality of members of the first user group, wherein each respective website is published for a respective member of the first user group.

8. The method of claim 1, wherein accessing the content includes accessing printable documents.

9. The method of claim 1, wherein accessing the content includes at least one of accessing a copy of the content, and accessing a reference associated with an existing copy of the content.

10. The method of claim 1, wherein
managing content includes at least one of adding content, deleting content, choosing content, formatting content, forwarding content, modifying content, tagging content, and approving content for delivery.

11. The method of claim 10, wherein choosing content includes choosing content from a database of content maintained by the provider.

12. The method of claim 1, further comprising a third-party content provider supplying the content.

13. The method of claim 1, further comprising accessing, by at least one of a member of the first user group and a member of the second user group, a newsletter including the content.

14. The method of claim 1, comprising receiving the content at the first user group in a newsletter.

15. The method of claim 1, further comprising providing the provider with content management tools.

16. The method of claim 1, wherein
receiving and modifying the content includes the first user group using content management tools.

17. The method of claim 1, comprising
tagging based at least in part on one of a subject matter categorization of the content portion, a source of the content portion, a title of the content portion, and a media type associated with the content portion.

18. The method of claim 1, comprising tagging a portion of the content with a plurality of hierarchically related tags representing categories of the content.

19. The method of claim 1, wherein at least one of the one or more tags includes information related to a preferred formatting of the content.

20. The method of claim 1, wherein tagging includes
categorizing the content as one of content provided by the provider that cannot be deleted by members of the first user group, content provided by the provider that can optionally be deleted by members of the first user group, content offered by the provider that may be included by members of the first user group, content created by a third-party provider, and content created by members of the first user group.

21. The method of claim 1, comprising
maintaining user profiles for members of the second user group, wherein managing the content includes comparing the one or more tags of the content portions and the user profiles of the members of the second user group.

22. The method of claim 21, comprising
choosing, by at least one of the provider and a member of the first user group, content targeted to members of the second user group based on a comparison of the one or more tags associated with the content and the respective user profiles of the members of the second user group.

23. The method of claim 1, further comprising
maintaining user profiles for members of the first user group, wherein
the provider chooses content directed to members of the first user group based on a comparison of the user profiles and the one or more tags associated with the content portions.

24. The method of claim 1, further comprising
detecting information about the content that at least one of a member of the first user group and a member of the second user group is viewing; and
at least one of the provider and a member of the first user group analyzing the detected information.

25. The method of claim 24, further comprising
establishing triggers for reporting the detected information based on at least one of predetermined time periods and actions taken by the first user group or the second user group, and reporting, by a reporter, the detected information according to the established triggers.

26. The method of claim 24, wherein
detecting information includes one or more of identifying metadata tags associated with the content, identifying which content each user is viewing, identifying how long each user is viewing the content, identifying how many times a particular link included in the content is clicked, and identifying how many unique users click on a particular link included in the content.

27. The method of claim 26, wherein
identifying metadata tags includes identifying one or more of a media type of the content, a source of the content, a title of the content, and a media type of a file associated with the content.

28. The method of claim 24, further comprising
providing a graphical interface for graphically displaying metrics associated with the detected information.

29. The method of claim 24, wherein
allowing the provider to manage content includes rating the content for subsequent delivery based on the analysis of the detected information.

30. The method of claim 24, further comprising
the provider maintaining a library of content and the provider modifying the library of content based on the analysis of the detected information.

31. The method of claim 24, further comprising
the provider further managing the content by choosing content directed to members of the first user group based on an analysis of the detected information.

32. The method of claim 24, wherein
detecting information about the content that members of the second user group are viewing includes detecting information specific to individual ones of the members of the second user group, and
personalized content is delivered to each of the members of the second user group based on the detected information specific to that member.

33. The method of claim 1, wherein accessing the content includes using a content syndication mechanism.

34. The method of claim 33, comprising accessing an RSS feed.

35. The method of claim 34, wherein accessing an RSS feed includes providing an email with a reference associated with the RSS feed.

36. The method of claim 34, wherein accessing an RSS feed includes providing a website with a reference associated with the RSS feed.

37. The method of claim 33, comprising syndicating at least one of audio and video.

38. The method of claim 1, wherein accessing the content includes providing access to a podcast.

39. The method of claim 38, further comprising the podcast distributing at least one of audio data and video data.

40. The method of claim 38, wherein accessing a podcast includes providing an email with a reference associated with an RSS feed.

41. The method of claim 38, wherein accessing a podcast includes accessing a website with a reference associated with an RSS feed.

42. The method of claim 1, comprising
providing the first user group with means to organize the members of the second user group into subscriber groups, and
providing the first user group with means to choose a different set of content to be delivered to respective subscriber groups.

43. The method of claim 42, comprising
organizing, by the first user group, members of the second user group into subscriber groups based on related user profiles for the members of the second user group.

44. The method of claim 1, comprising
providing the provider with means to organize at least one of the members of the first user group and the members of the second user group into subscriber groups, and
providing the provider with means to choose a different set of content to be delivered to respective subscriber groups.

45. The method of claim 44, further comprising
the provider organizing the members of the first user group and the members of the second user group based on related user profiles for the members of the first user group and second user group.

46. The method of claim 1, further comprising
providing a plurality of content portions over the network,
assigning one or more tags to the portions of the content based on respective categorizations of the content portions,
assigning a user profile to the members of the user groups based on at least one of input from the respective users and information associated with the respective users,
choosing, by a first filter, content to be delivered from the provider to the respective members of the first user group by comparing the one or more tags with the user profiles of the members of the first user group, and
modifying, by a second filter, the provided content by comparing the one or more tags with the user profiles of the members of the second user group.

47. The method of claim 46, wherein
assigning a tag to a portion of the content includes assigning a plurality of tags to the content portion in a hierarchical sequence, each tag in the sequence identifying a narrower categorization of the content portion than the preceding tag in the sequence.

48. The method of claim 47, wherein
assigning a user profile to a member includes assigning a user tag identifying a category of interest to the member, and
matching, by at least one of the first filter and the second filter, the user tag to at least one tag in the hierarchical sequence of tags.

49. The method of claim 46, further comprising accessing the content using a content syndication mechanism.

50. The method of claim 46, wherein accessing the content includes accessing a Podcast.

51. A method for providing content over a network from a provider to a plurality of user groups, including a first user group and a second user group, comprising:
managing and publishing the content, from the provider, being provided to the first user group,
receiving and managing, by at least one member of the first user group, the published content;
identifying, by at least one member of the first user group, a second user group for receiving the content, the second user group being different from the first user group;
accessing, by at least one member of the second user group, the content; and
analyzing, by at least one of the provider and the first user group, the detected information.
